(19) United States
(12) Patent Application Publication
(10) Pub. No.: US 2026/0197814 A1
(43) Pub. Date: Jul. 9, 2026

(54) MANAGEMENT OF SHARED RESOURCE POOLS FOR SCHEDULING REQUESTS

(71) Applicant: QUALCOMM Incorporated, San Diego, CA (US)

(72) Inventors: Raviteja PATCHAVA, San Diego, CA (US); Yan ZHOU, San Diego, CA (US); Jing SUN, San Diego, CA (US); Junyi LI, Greentown, PA (US)

(21) Appl. No.: 19/011,292

(22) Filed: Jan. 6, 2025

(51) Int. Cl. H04W 72/12

(52) U.S. Cl. CPC H04W 72/12

(57) ABSTRACT

Certain aspects of the present disclosure provide techniques methods, systems or an apparatus configured to receive an indication of a scheduling request (SR) resource pool; and send an SR using an SR resource of SR resources of the SR resource pool, wherein the SR resource on which the SR is sent indicates information relating to at least one of a requested number of uplink (UL) resources or modulation and coding scheme (MCS) information.

### INTRODUCTION

### Field of the Disclosure

Aspects of the present disclosure relate to wireless communications, and more particularly, to techniques for managing uplink resources in shared resource pools.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes receiving an indication of a scheduling request (SR) resource pool (SR RP); and sending a scheduling request (SR) using an SR resource of SR resources of the SR RP, wherein the SR resource on which the SR is sent indicates information relating to at least one of a requested number of uplink (UL) resources or modulation and coding scheme (MCS) information.

Certain aspects provide a method for wireless communication by a network entity (NE). The method includes sending an indication of an SR RP; and receiving an SR using an SR resource of SR resources of the SR RP, wherein the SR resource on which the SR is received indicates information relating to at least one of a requested number of UL resources or MCS information.

Other aspects provide: one or more apparatuses operable, configured, or otherwise adapted to perform any portion of any of the methods described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of a scheduling request resource pool (SR RP).

FIG. 6 depicts an example of an SR RP.

FIG. 7 depicts an example of another aspect of an SR RP.

FIG. 8 depicts a process flow for communications in a network between a network entity (NE) and a UE.

FIG. 9 depicts a process flow for communications in a network between an NE and multiple UEs.

FIG. 10 depicts a method for wireless communications.

FIG. 11 depicts aspects of an example communications device.

FIG. 12 depicts another method for wireless communications.

FIG. 13 depicts another example communications device.

### DETAILED DESCRIPTION

Aspects of the present disclosure provide apparatuses, methods, processing systems, and computer-readable mediums for managing uplink resources in shared resource pools.

A scheduling request (SR) is a mechanism by which a UE requests uplink (UL) resources (time-frequency resources for communications) from a network entity (NE), such as a gNodeB (gNB), so that the UE may transmit data to the gNB on the UL resources after the resources are granted by the NE.

Typically, SRs are initially transmitted by the UE on a configured physical uplink control channel (PUCCH). If the PUCCH is unavailable, then the SR is transmitted on contention-based random access (CBRA) resources on a physical random access channel (PRACH). CBRA resources are utilized often as PUCCH is often unavailable and used for other processes in communication with the NE. These other tasks may include the transmission of various indicators, such as hybrid automatic repeat request feedback, channel state information, or beam management reporting.

Using PRACH for SR transmissions can lead to inefficiencies, because the transmission of SRs on PRACH causes the NE to automatically provide timing information to the UE in response. Timing information is not always desired by the UE, as obtaining it may include additional processing, delays, and increases latency to the resource grant process. Furthermore, using CBRA resources may be problematic in the presence of a large number of UEs, since a higher the number of UEs attempting to access these resources is associated with a higher number of collisions and consequent failed transmissions, thus leading to retransmissions, causing delays, and placing a higher compute load on both the NE and the UEs.

Aspects presented herein provide for techniques to overcome inefficiencies in the resource grant process by configuring an SR resource pool (SR RP) that comprises a set of resources allocated to SRs. The SR RP can be shared by multiple UEs. The SR RP may enable the NE to flexibly and efficiently allocate requested resources, e.g., UL data resources of varying sizes based on the received SRs, across the UEs. The aspects disclosed herein include a UE receiving an indication of an SR RP from an NE, and then the UE sending an SR based on the configured SR RP (e.g., on a resource of the SR RP).

In some aspects, a selected resource on which the UE sends the SR indicates information associated with the SR. For example, the selected resource may indicate a requested number of uplink resources. As another example, the selected resource may indicate modulation and coding scheme (MCS) information, such as a requested MCS, for the uplink grant. As another example, the selected resource may indicate a number of repetitions of the SR.

In some aspects, the SR RP may be unsourced, meaning that a specific UE's transmission of an SR on a resource of the SR RP does not indicate the specific UE. The NE may resolve this ambiguity by providing a UL grant that identifies the resource on which the SR was transmitted. Subsequently, the UE may send an indication of the UE's identity on a resource granted by the UL grant.

The disclosed aspects of receiving an indication of an SR RP from an NE provide technical advantages over using PRACH for SRs. Relative to using PRACH for SRs, the resources in an SR RP are allocated to SRs and configured as such, and therefore do not provide information or perform additional processing that is not requested by the UEs, reducing latencies relative to PRACH usage.

Furthermore, because these resources in the SR RP are associated to SRs, they will not be used by other processes or allocated to other types of signaling, and therefore may be more readily available and allocated more frequently for SR use. In some aspects, the RP and its resources are exclusive for SR use. In some aspects, the RP can be allocated to SRs as well as to other procedures such as hybrid automatic repeat requests (HARQ), e.g., to transmit small amounts of UL data. Whether the SR RP is exclusive to SR use or not, the RP limits general use of its resources, making them more readily available. These more readily available SR RP resources reduce collisions associated with CBRAs.

Furthermore, because the selected resource indicates information associated with the SR, overhead is reduced relative to explicitly providing this information via the SR, and implicit provision of this information is enabled relative to other approaches like PRACH transmission of SRs (where such implicit indication may not be possible). Also, the unsourced nature of the SR transmission increases the number of addressable UEs in an SR RP of a given size or configuration.

The technical benefit of the UE sending the SR on the SR RPs include the flexibility to dynamically configure the number and types of resources allocated for SRs to respond to network conditions such as traffic. Different SR RP configurations that respond to the SRs that are sent on the SR RP may help improve network efficiency based on efficient resource allocation to the SR RPs, by allocating the highest number of resources that can maximize SRs while minimizing effect on other network processes to reduce delays and latencies across the network.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

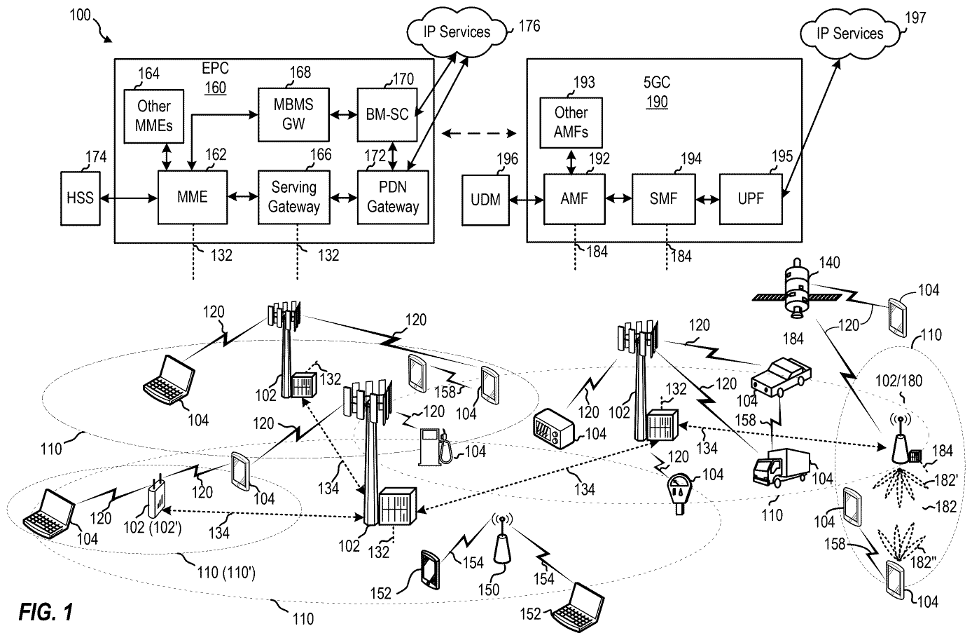

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

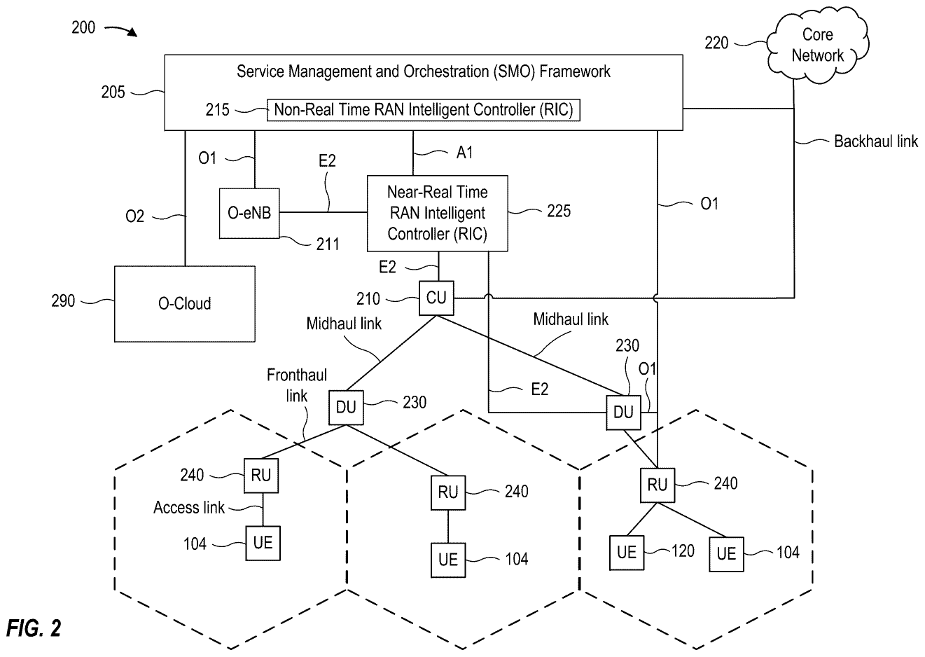

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1(FR1 ) as including 410 MHz-7125 MHz, which is often referred to (interchangeably) as “Sub-6 GHz”. Similarly, 3GPP currently defines Frequency Range 2(FR 2 ) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

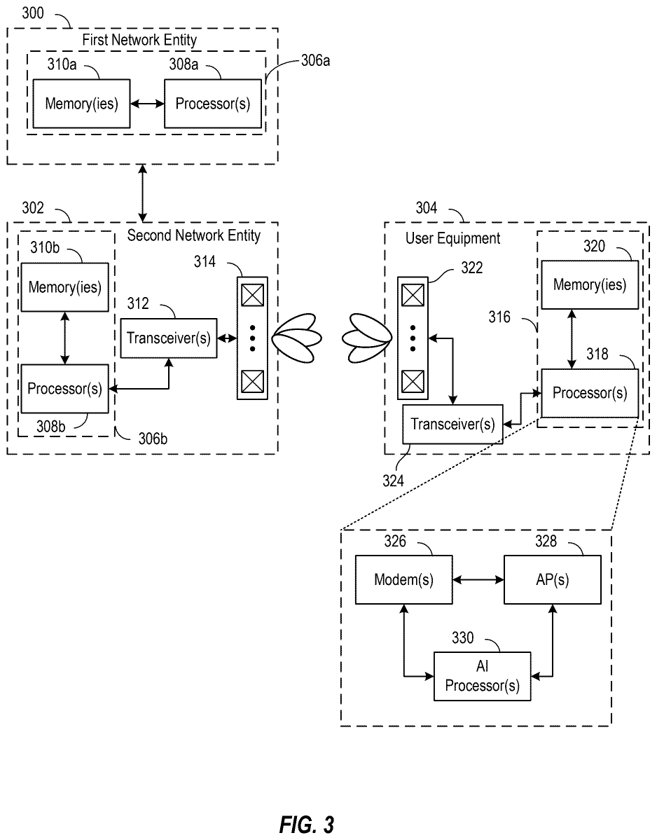

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

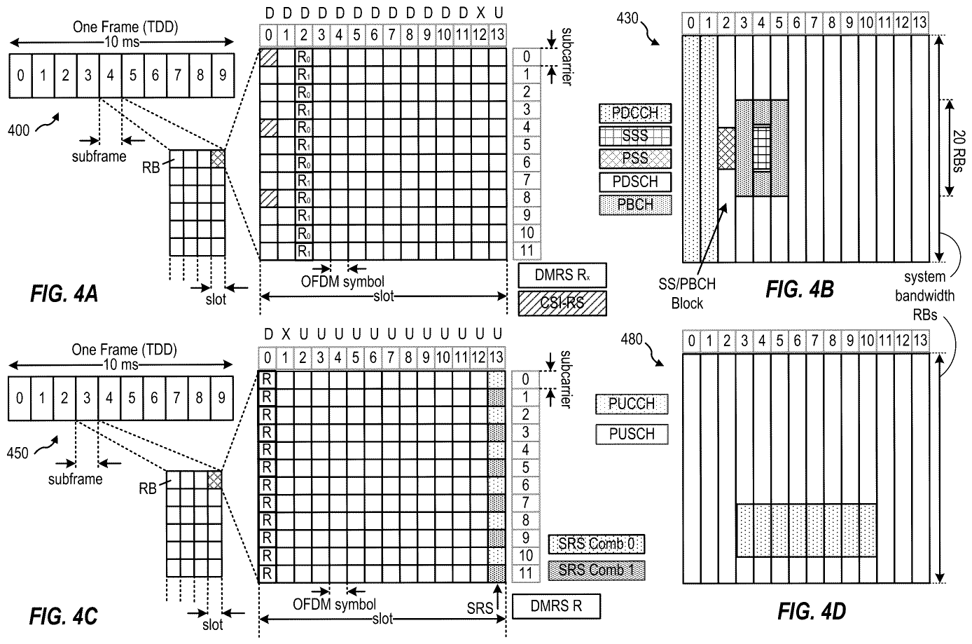

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μb ×15} kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs. As depicted in FIGS. 4A, 4B, 4C, and 4D, a resource grid may be used to

represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Managing Uplink Resources in Shared Resource Pools

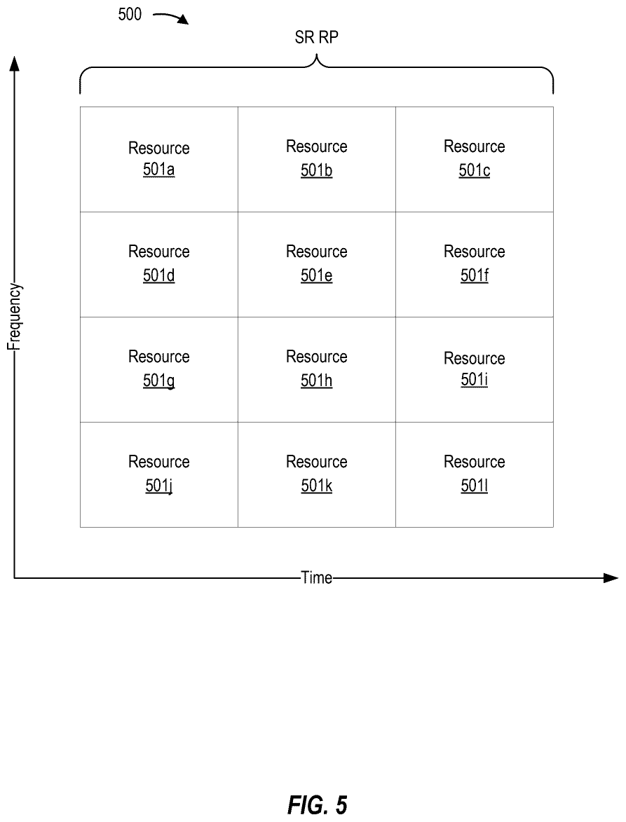

FIG. 5 depicts an example of a scheduling request resource pool (SR RP) 500. The SR RP 500 comprises a number of resources 501. The resources 501 are time/frequency resources used by NEs and UEs (not shown) for communications over a telecommunication network. The resources 501 may be configured by an NE to provide resources for UEs to transmit SRs on.

In some aspects, an NE described in relation to FIG. 5 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, a UE may be an example of UE 104 depicted and described with respect to FIG. 1 or the UE 304 depicted and described with respect to FIG. 3. However, in other aspects, a UE may be another type of wireless communications device and a network entity may be another type of network entity or network node, such as those described herein.

In some aspects, one resource 501a may be used by a first UE, and a second resource 501a may be used by a second UE, and so on. In some aspects, the indication of the SR RP 500, e.g., identifying the resources of the resource pool, is sent to the UEs from an NE. The indication could be sent to UEs through an SIB, e.g., to multiple UEs, or individually to a UE via dedicated RRC signaling. The indication of the SR RP 500 may indicate specific resources 501 included in the SR RP 500, a set of sequences configured for a resource 501, a number of repetitions associated with a resource 501, a number of resources indicated by an SR transmitted on a resource 501, or other information, as described elsewhere herein.

The resources of the SR RP 500 are accessed and transmitted on randomly by the UE when the UE sends an SR to the NE. Because of this random access, and because the SR does not include information identifying the UE, the NE does not know which UE transmitted the SR (that is, it is an unsourced SR). Both the unsourced nature of the transmission as well as the random selection of the resource reduce complexity in the SR process. An unsourced SR allows a higher number users or UEs because less information is transmitted, and/or less resources 501 of the SR RP 500 are being used, per SR transmission. These smaller transmissions allows a higher total number of SRs to be handled in the SR RP 500. In some aspects, even assuming a large number of UEs or users, the aperiodic nature of UE SR transmission leads to a small average load on the SR RP since the SRs are transmitted by the various UEs aperiodically (and thus typically occur at different times). However, in the context of scheduled/source SR transmission, the NE has to allocate SRs assuming that all the SRs occur together, which increases latency since the NE cannot optimize SR resource allocation based on the actual lower load on the network but based on an assumed larger load on the network. In some aspects, a UE identifier (UE ID) of the UE may be provided in other resources, e.g., granted PUSCH resources, as part of the resource grant in response to the SR. The UE may utilize a radio network temporary identifier (RNTI), such as a cell RNTI (C-RNTI) or an inactive RNTI (I-RNTI) as the UE ID in these granted PUSCH resources.

In some aspects, the SR may be a sequence based waveform, e.g., PUCCH format 0. The sequence based waveform may be associated with lower overhead than other forms of uplink signaling.

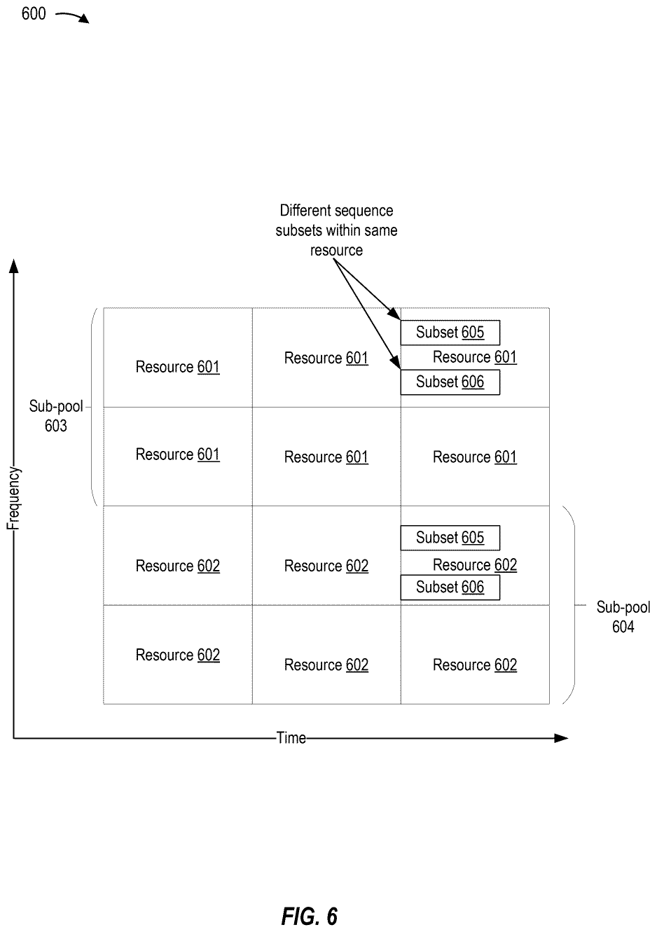

FIG. 6 depicts an example of an SR RP 600. The SR RP 600 includes a first sub-pool 603 of resources 601 and a second sub-pool 604 of resources 602. The resources 601, 602 are time/frequency resources used by NEs and UEs for communications over a telecommunication network. The SR RP 600 may be an example of SR-RP 500. The resources 601 and 602 may be examples of resource 501. A sub-pool of resources comprises a subset of resources of an SR RP, such as a proper subset of resources of the SR RP.

In some aspects, an NE described in relation to FIG. 6 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, a UE described in relation to FIG. 6 may be an example of UE 104 depicted and described with respect to FIG. 1 or the UE 304 depicted and described with respect to FIG. 3. However, in other aspects, a UE may be another type of wireless communications device and a network entity may be another type of network entity or network node, such as those described herein.

The resources 601, 602 may be configured by an NE to provide resources for UEs to transmit SRs on. The SR RP 600 is configured to support flexible resource allocation of SRs. “Flexible resource allocation” refers to the SR RP 600 supporting indication of different parameters, such as a number of granted resources, a number of repetitions of the SR, or MCS information, according to which resource 601 or 602 is used to transmit the SR. Additionally or alternatively, “flexible resource allocation” may refer to the SR RP 600 being capable of allowing different amounts of resources 601 and 602 to be allocated to UEs, based on the varying resource amounts requested by their SRs. In some aspects, a first resource 601 may be used by a first UE, a second resource 602 may be used by a second UE, and so on. For example, different sub-pools may be configured for different UEs or different sets of UEs.

A UE may send multiple bits of information to the NE via the SR it sends on the resources 601, 602 in the SR RP 600. In some aspects, a resource 601 or a resource 602 may indicate one or more bits of the multiple bits of information. For example, an SR may indicate part of the multiple bits of information, and the resource 601 or 602 may implicitly indicate a remainder of the multiple bits of information. For example, the selected resource 601 or 602 may indicate a particular amount of UL resources from multiple different amounts of UL resources, e.g., for different types of communications. As another example, the selected resource 601 or 602 may indicate a selected MCS from multiple different MCSs, configured for different resources 601 or 602, to be used in the UL grant or subsequent transmissions. These MCSs may be based on UE estimations or measurements, e.g., estimates based on a previous MCS or based on open loop measurements. These different requests or multiple bits of information may be transmitted via SRs, the resources 601, 602, or a combination thereof.

In some aspects, to configure the SR RP 600 for flexible resource allocation, the NE configures the SR RP 600 by splitting it into the first sub-pool 603 and the second sub-pool 604, where each of the sub-pools 603, 604 may be designated to indicate certain bits or types of information. For example, each sub-pool 603, 604 may be associated with a number of repetitions, MCS information, or an UL grant size. A UE may first select a sub-pool from the sub-pools 603 and 604 according to a desired UL grant size, number of repetitions, or MCS. The UE may select the resource 601, 602 to transmit the SR randomly from the selected sub-pool 603 or 604.

In some aspects, a resource 601 or 602 may be configured with multiple sequences. A UE that transmits an SR on the resource 601 or 602 may use a sequence from the multiple indicated sequences to transmit the SR, such as to generate a waveform of the SR. In some aspects, a resource may be associated with multiple sets of sequences 605 and 606 from a plurality of sequences configured for the resource. A first set of sequences 605 may indicate a first parameter (such as a number of repetitions, MCS information, or an UL grant size). A second set of sequences 606 may indicate a second parameter (such as a number of repetitions, MCS information, or an UL grant size). The UE may, depending on the information to transmit, select a set of sequences from the multiple sets of sequences 605 and 606, and then may select a sequence from the selected set of sequences 605 or 606.

In some aspects, a UE may select both a sequence (or e.g., a set of sequences 605/606) and a resource (or sub-pool 603/604). Thus, the UE can indicate a first parameter via the sequence or set of sequences (such as a UL grant size) and a second parameter via the sub-pool (such as MCS information). Thus, the flexibility of such indications is increased.

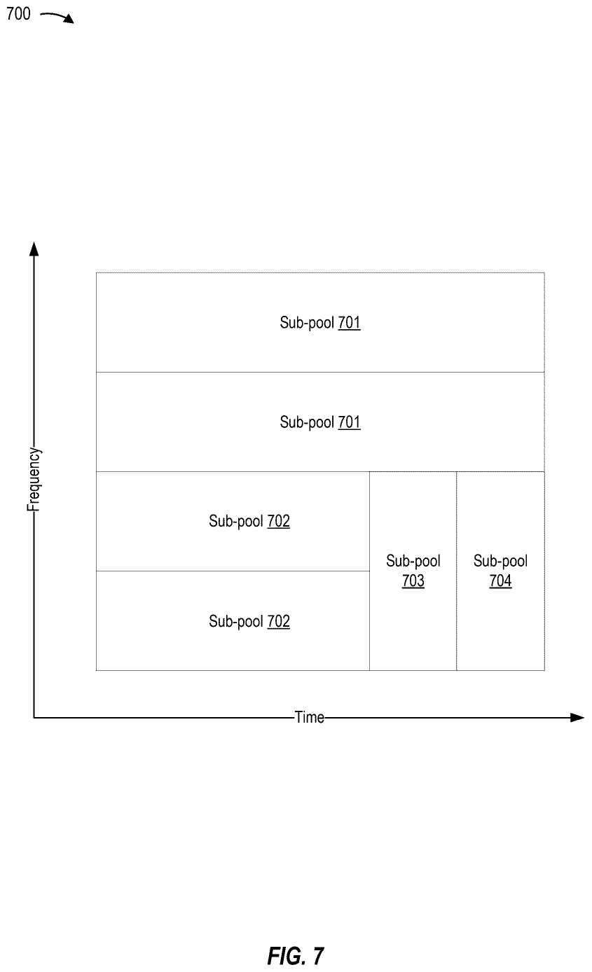

FIG. 7 depicts an example of another aspect of an SR RP 700 that supports different SR repetitions. The SR RP 700 may be an example of SR RP 500 or SR RP 600. The SR RP 700 can be configured by an NE to include multiple sub-pools. For example, a first sub-pool 701, a second sub-pool 702, a third sub-pool 703, and a fourth sub-pool 704 are configured. Each of the sub-pools 701-704 comprise resources, e.g., resources 501 of FIG. 5 or resources 601 or 602 of FIG. 6. The resources in the SR RP 700 are time/frequency resources used by NEs and UEs for communications over a wireless communications network. Similar to FIG. 6, the NE can configure the SR RP 700 to be able to flexibly allocate resources. In some aspects, an NE described in relation to FIG. 7 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, a UE may be an example of UE 104 depicted and described with respect to FIG. 1 or the UE 304 depicted and described with respect to FIG. 3. However, in other aspects, a UE may be another type of wireless communications device and a network entity may be another type of network entity or network node, such as those described herein.

In some aspects, the NE configures one or more of the sub-pools 701-704 to be associated with a different number of SR repetitions to improve coverage. An SR repetition refers to the number of SRs sent by a UE. For example, a UE with a weak signal or in a high interference environment may need to send the same SR repeatedly until it is successfully received by the NE. For example, the first sub-pool 701 may be configured to allow for a symbol sequence with four repetitions (e.g., a one-symbol sequence with four repetitions), the second sub-pool 702 may be configured to allow a symbol sequence of two repetitions (e.g., a two-symbol sequence with two repetitions), while the third sub-pool 703 and the fourth sub-pool 704 may be configured to allow one repetition each (e.g., a four-symbol sequence with one repetition), where each repetition is an attempted SR transmission.

A UE may select one of the configured sub-pools 701-704 based on a rule (such as a rule that is specified in a wireless communication specification) or based on an indication from an NE. For example, the NE may configure the rule. In some aspects, the UE may also use its own internal rules, or an implicit rule (e.g., hardcoded into specifications) to determine which of the sub-pools 701-704 to select. For example, the UE may select the sub-pool based on a reference signal received power (RSRP) which denotes signal strength. For example, a first range of RSRPs may be mapped to a first sub-pool, a second range of RSRPs would be mapped to a second sub-pool, and so on. This improves the likelihood that the SR communication overcomes the weak signal and is received successfully by the NE.

In some aspects, the NE configures the rule for sub-pool selection, e.g., via an indication sent to the UE. The NE may configure selection of a sub-pool of a certain number of repetitions by the UE based on certain parameter levels. For example, the NE may provide a mapping between a UE RSRP levels and number of repetitions, e.g., a low RSRP may be mapped to a sub-pool with a high number of repetitions and vice versa. In some aspects, rules may be associated with specific sub-pools or characteristics of sub-pools. For example, the first sub-pool 701 may be associated with a first selection rule, the second sub-pool 702 may be associated with a second selection rule, the third sub-pool 703 may be associated with a third selection rule, and the fourth sub-pool 704 may be associated with a fourth selection rule. The selection rules may be associated with the number of repetitions or other attributes of the sub-pools based on the NE configuration. The selection rules may be based on one or more implicit UE rules. An implicit UE rule is a UE-determined rule that sets UE actions based on UE status (e.g., current UE state and operating conditions). For example, the selection rules may set the mapping between UE RSRP levels and the number of repetitions, which the UE may use to determine the sub-pool. For example, a UE RSRP of x may be mapped to a y number of repetitions, and therefore a UE with the RSRP of x selects a sub-pool out of the sub-pools 701-704 that corresponds to y number of repetitions.

### Example Signaling for Managing Uplink Resources in Shared Resource Pools

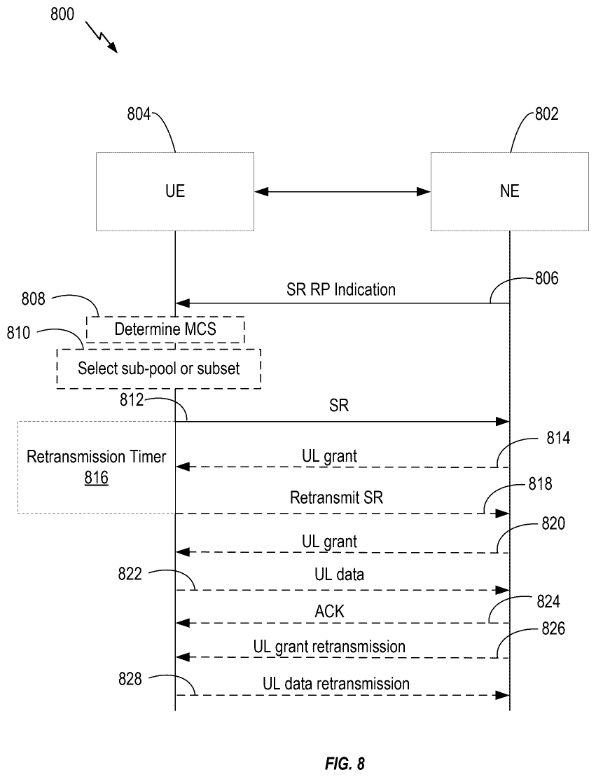

FIG. 8 depicts a process flow 800 for communications in a network between an NE 802 and a UE 804. In some aspects, the NE 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and NE 802 may be another type of network entity or network node, such as those described herein. Note that any operations or signaling illustrated with dashed lines may indicate that that operation or signaling is an optional or alternative example.

In some aspects, the process flow 800 begins at 806 with the NE 802 sending and the UE 804 receiving an indication of an SR RP. The SR RP may correspond to the SR RP 500, 600, or 700 of FIG. 5, FIG. 6, or FIG. 7, respectively. The indication may be a configuration of the SR RP. The SR RP may be configured for flexible resource allocation. For example, the SR RP can be configured to support SRs requesting varying amounts or numbers of resources. In some aspects, the indication may include a configuration of resources in an SR RP. The resources in the SR RP may include at least one of a sequence resource or a time and frequency (time/frequency) resource. For example, “resource” or “SR resource,” in the context of an SR RP, may refer to a time/frequency resource (e.g., resource 501, 601, 602), a sequence used to generate or transmit an SR, or a combination thereof. In some aspects, the indication received at 806 may additionally, or alternatively, include a sub-pool or subset indication or configuration, for example to provide information to the UE to select resources from the SR RP as is discussed above in FIG. 6 and FIG. 7, e.g., in relation to sub-pools and subsets of sequences. In some aspects, the indication is sent via an SIB to one or more UEs or a dedicated RRC signal individually to the UE 804.

In some aspects, at 808 the UE 804 may determine an MCS. For example, the UE 804 may determine the MCS based on the indication received at 806. As another example, the UE 804 may determine the MCS based on an open loop measurement associated with the indication, or based on previous MCS information. In some aspects, at 810, the UE 804 may select the sub-pool or subset. For example, the UE 804 may select the sub-pool or subset based on the indication received at 806 (e.g., according to a mapping between the sub-pool or subset and a parameter such as MCS, a number of requested resources, or a number of repetitions).

The UE 804 at 812 may send and the NE 802 may receive an SR via an SR resource of the SR RP. In some aspects, the resource on which the SR is transmitted indicates information relating to at least one of a requested number of UL resources or MCS information. The MCS information may include the MCS determined at 808. The SR resource may be a randomly selected SR resource. In some aspects, the SR may comprise a request for multiple UL resources. The SR resource may be a randomly selected resource from the subset or sub-pool selected at 810.

In some aspects, at 814 the NE 802 sends and the UE 804 receives a resource grant, e.g., a UL resource grant. In some aspects, the resource grant is sent to the UE based on an SR radio network temporary identifier (SR-RNTI) which is associated with the SR sent at 812 (or the resource or sequence used to transmit the SR) rather than with the UE itself. For example, the SR-RNTI may be a hashed time/frequency resource value based on the resource location (that the SR is transmitted on at 812) and/or another identifier, such as a sequence identifier for the SR RP.

In some aspects, the UL grant at 814 is transmitted via DCI, and the DCI may have a cyclic redundancy check (CRC) scrambled using the SR-RNTI. The CRC may refer to a checksum that may be scrambled and unscrambled to detect transmission errors at the receiver. The DCI at 814 may indicate information regarding multiple sequences in the SR resource location. In some aspects, for each SR sequence detected, the NE may allocate UL grant resources (e.g., a set of UL grant resources per detected SR sequence). The UE may, depending on the transmitted SR sequence, select resources from the allocated resources in the UL grant for transmission (e.g., resources corresponding to the transmitted SR sequence). For example, the DCI at 814 may indicate a specific sequence, of multiple sequences associated with a resource that was used for the SR. Thus, a recipient of the DCI at 814 can discern a specific SR by reference to the sequence that was used to transmit to the specific SR. In some aspects, the DCI may include the UL grant. In some aspects, the DCI may indicate PDSCH resources that contain UL grant information, and the UE may receive the UL grant information via the PDSCH resources.

In some aspects, the UL grant is carried in one or more dedicated DCI fields. For example, the UL grant may be transmitted using DCI, and the DCI may carry the UL grant as well as an indication of a sequence associated with the UL grant or the SR.

In some aspects, the NE 802 may provide a transmit power control (TPC) value in the UL grant at 814 for UL data to be sent by the UE 804. The TPC value comprises data or signals that indicate a transmission power of the UE 804 when sending the UL data for which the UL grant provides resources. This TPC value may be based on the measured power of the SR at the NE 802, a target received power of the SR, or a combination thereof. In some aspects, the TPC value may be based on an MCS allocation in the UL grant. The MCS allocation itself may be based on the MCS information in the SR received by the NE at 812. For example, the TPC value may be set based on comparing a received power of the SR to a received power of uplink data.

In some aspects, after sending the SR at 812, the UE 804 may monitor for a resource grant, e.g., associated with an SR-RNTI, during a retransmission timer 816, e.g., a grant monitoring window. The retransmission timer 816 may be configured by the NE 802, for example via the indication at 806. The retransmission timer 816 may be an SR-RNTI monitoring window where the UE 804 monitors for a UL grant that is based on SR-RNTI, e.g., the UL grant contains information or an SR-RNTI that includes or is formed based on the resource location and sequence identifier in the resource of the SR RP that the UE 804 used at 812 to transmit the SR. The length of the SR-RNTI monitoring window configured by gNB, and if the UE 804 does not receive a UL grant within the window, then UE 804 may retransmit the SR. If the retransmission timer 816 passes without the UE 804 receiving the UL grant at 814, then the UE 804 retransmits the SR at 818. In other words, the duration of the retransmission timer 816 may run from transmission of the SR at 812 until expiration, which triggers retransmission of the SR at 818. In some aspects, if the UE 804 does not receive the UL grant at 814, then it may retransmit the SR at 818 with increased power. In some aspects, the UE 804 may apply a back off or a delay between SR transmissions and retransmission to minimize the likelihood of collisions. In some aspects, if the UE 804 is unsuccessful after a predefined number of SR transmissions or retransmissions at 812 and 818, then the UE may transmit a PRACH to obtain timing and a grant of UL resources from the NE 802.

The NE 802 may then send and the UE 804 may receive a UL grant at 820 as discussed above. For example, if the UL grant is not received at 814, and if the UE 804 retransmits the SR at 818, the UE 804 may receive the UL grant at 820. Thus, the UE 804 may receive only one of the UL grant at 814 or the UL grant at 820.

In some aspects, once the UL grant is received by the UE 804 at 814 or at 820, then the UE 804 may transmit, and the NE 802 may receive the UL data at 822 via the granted UL resources. The UE 804 can send the UL data it has stored in a buffer at 822, together with other information (e.g., a UE ID, such as a C-RNTI or an I-RNTI). In some aspects, at 822 the UE 804 may also transmit a buffer status report (BSR) to request additional resources. If the resource in the SR RP has been used to transmit more than one SR, then multiple UEs may transmit on the same granted UL resource, causing collisions and transmission failures.

In some aspects, at 824, the NE 802 after receiving UL data from the UE 804 at 822, can send an acknowledgement to the UE 804, for example as a DCI with the UE ID or the C-RNTI associated with the UE 804. This acknowledgement at 824 informs the UE that its UL data was received successfully at 822. In some aspects, the acknowledgement sent at 824 may schedule additional data transmissions. If the acknowledgment (e.g., DCI) schedules additional data transmission, and the UE 804 does not have more data to transmit, the UE 804 may transmit a BSR indicating no available data.

In some aspects, instead of an acknowledgement at 824, the NE 802 sends another UL grant or a retransmission of the UL grant at 826, e.g., if it is unable to successfully decode the UL data sent at 822, to allow the UE 804 to retransmit the UL data at 828.

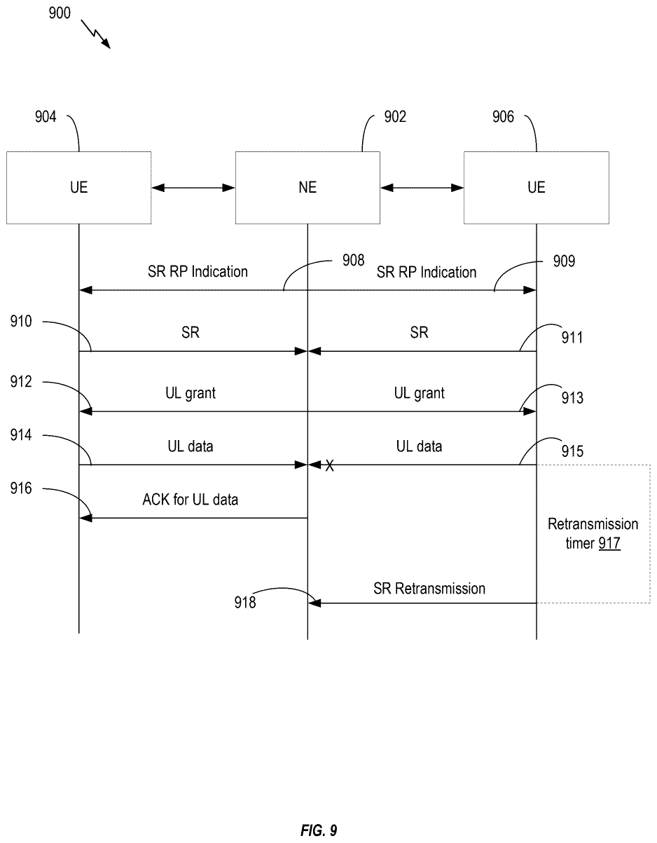

FIG. 9 depicts a process flow 900 for communications in a network between a NE 902, a UE 904, and a UE 906. FIG. 9 describes error cases between the NE 902 and multiple UEs, e.g., the UEs 904 and 906, when an SR RP is configured.

In some aspects, the NE 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 and the UE 906 may be examples of UE 104 depicted and described with respect to FIG. 1 or the UE 304 depicted and described with respect to FIG. 3. However, in other aspects, UE 904 and the UE 906 may be other types of wireless communications device and NE 902 may be another type of network entity or network node, such as those described herein. Note that any operations or signaling illustrated with dashed lines may indicate that that operation or signaling is an optional or alternative example.

At 908, the NE 902 may send an SR RP indication to one or more UEs, e.g., the UE 904. At 909, the NE 902 may send an SR RP indication to one or more UEs, e.g., the UE 906. Each of the communications at 908 and 909 may correspond to the SR RP indication 806 of FIG. 8. This may be a single SR RP indication at both 908 and 909 or multiple SR RP indications at 908 and 909, respectively.

At 910, the UE 904 may send and the NE 902 may receive an SR. At 911, the UE 906 may send and the NE 902 may receive an SR. Each of the communications at 910-911 may correspond to the communications at 812 of FIG. 8. In some aspects, both the UE 904 and the UE 906 may transmit on the same SR RP resource at 910 and 911, respectively. Sending the SR at any of 910 or 911 may correspond to sending the SR at 812 of FIG. 8.

Based on the SRs at 910 and 911, the NE 902 may send a UL grant of UL resources at 912 to the UE 904, and may send a UL grant of UL resources at 913 to the UE 906. The UL grant may be for the same UL resources if both UEs 904 and 906 transmitted the SR on the same SR resources and requested the same UL resources for UL data transmission. Any of the UL grants at 912 and 913 may correspond to the UL grants 814 or 820 of FIG. 8 and their accompanying details.

At 914 the UE 904 may send UL data to the NE 902 on the UL resources granted at 912. At 915 the UE 906 may send UL data to the NE 902 on the UL resources granted at 913. Sending UL data at 914 and at 915 may correspond to the sending of UL data at 822 of FIG. 8. Because both UEs sent the UL data on the same UL resources, a UL data collision occurs which prevents the NE 902 from receiving the UL data from one or more of the transmissions at 914 and 915.

At 916, the NE 902, may send an acknowledgement transmission to the UE 904 based on receiving the UL data at 914 from the UE 904 to let the UE 904 know that its UL data has been received and decoded successfully by the NE 902. This may correspond to the acknowledgment sent at 824 of FIG. 8.

When both the UEs 904 and 906 transmit the SRs at 910 and 911 on the same SR resource, the UEs 904 and 906 may receive the same UL grant at 914 and 915 (respectively) for the same UL resources. Therefore, UEs 904 and 906 may transmit on the same UL resources at 914 and 915, respectively, meaning that there can be a data collision between 914 and 915, where the NE 902 fails to receive the UL data at 915. For example if the UL data is sent at 915 and an acknowledgement is not received by the UE 906 within an acknowledgement window such as a retransmission timer 917, then the UE 906 will retransmit the SR at 918 upon expiry of the retransmission timer 917. In some aspects, the retransmission timer 917 may correspond to the retransmission timer 816 of FIG. 8. Failure to receive a UL grant within a specific duration, e.g., duration of the retransmission timer 917 may also serve as a non-receipt of acknowledgement. The retransmission at 918 may correspond to the retransmission at 818 of FIG. 8. The SR retransmission at 918 may be sent with power ramping. Power ramping refers to increasing the power of a transmission so that the transmission is more likely to be successfully received. Power ramping may also be used to provide performance differentiation among different traffic classes. In some aspects, the UE 906 resends the SR on another SR resource of the SR resource pool, or on another SR resource pool. In some aspects, the UE 906 resends the SR in association with a delay.

If the UE 906 is not successful at transmitting the SR after a predefined number of SR transmissions/retransmissions, then it may transmit PRACH to acquire timing and UL grant resources.

Note that the process flow illustrated in FIGS. 8-9 are examples of UL grants by SR RPs, and aspects of the present disclosure may be applied to process flows 800 and 900. Note that the process flow illustrated in FIGS. 8-9 are described herein to facilitate an understanding of managing uplink resources in shared resource pools, and aspects of the present disclosure may be performed in various manners via alternative or additional signaling and/or operations. In certain aspects, the operations and/or signaling of FIGS. 8-9 may occur in an order different from that described or depicted, and various actions, operations, and/or signaling may be added, omitted, or combined.

### Example Operations of a User Equipment

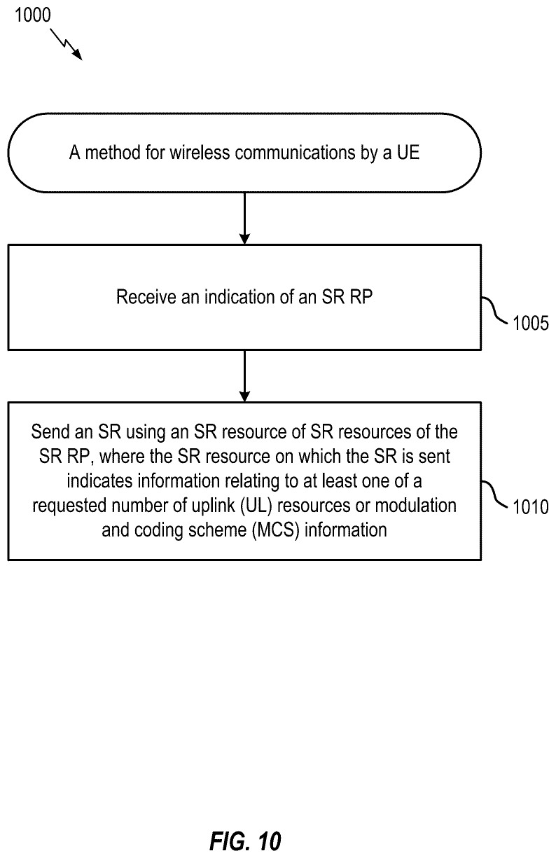

FIG. 10 shows a method 1000 for wireless communications by a UE, such as UE 104 of FIG. 1 or UE 304 of FIG. 3.

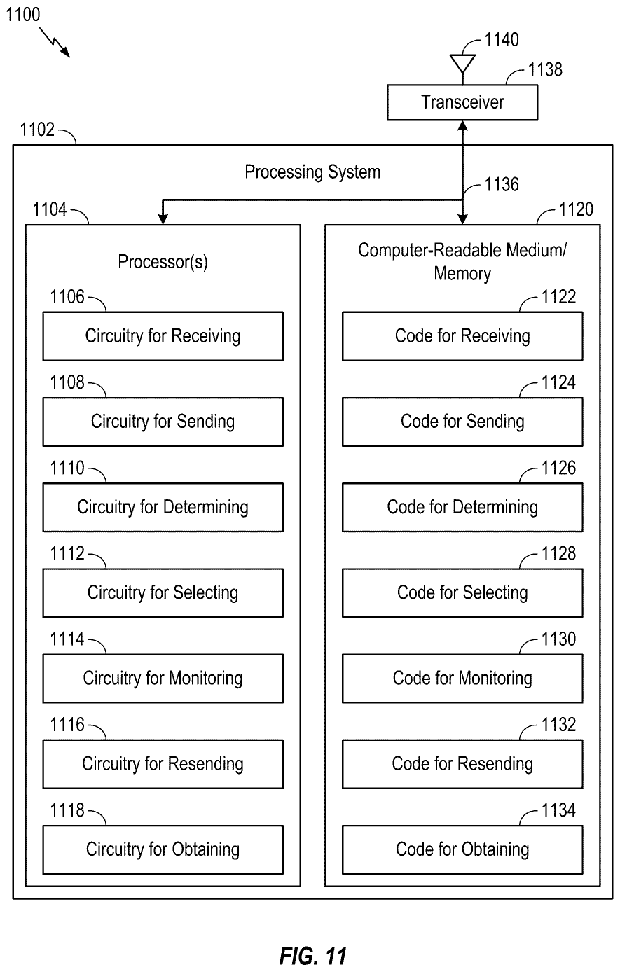

Method 1000 begins at block 1005 with receiving an indication of an SR RP. Block 1005 may correspond to 806 of FIG. 8, and 908 or 909 of FIG. 9. Receiving an indication of an SR RP (e.g., SR RPs) from an NE provide technical advantages over using PRACH for SRs. Relative to using PRACH for SRs, the resources in an SR RP are allocated to SRs and configured as such, and therefore do not provide information or perform additional processing that is not requested by the UEs, reducing latencies relative to PRACH usage. The block 1005 may also be implemented by a processor or memory or by an example communications device as described in FIG. 11.

Method 1000 then proceeds to block 1010 with sending a SR using an SR resource of SR resources of the SR RP, where the SR resource on which the SR is sent indicates information relating to at least one of a requested number of UL resources or MCS information. Block 1010 may correspond to 806 of FIG. 8, and 910 or 911 of FIG. 9 The technical benefit of the UE sending the SR on the SR RPs include the flexibility to dynamically configure the number and types of resources allocated for SRs to respond to network conditions such as traffic. Different SR RP configurations that respond to the SRs that are sent on the SR RP may help improve network efficiency based on efficient resource allocation to the SR RPs, by allocating the highest number of resources that can maximize SRs while minimizing effect on other network processes to reduce delays and latencies across the network. The block 1010 may also be implemented by a processor or memory or by an example communications device as described in FIG. 11.

In some aspects, the indication is of a configuration of the SR resources.

In some aspects, the SR resource comprises at least one of a sequence or a time and frequency (time/frequency) resource.

In some aspects, the MCS information comprises an MCS value.

In some aspects, sending the SR on the SR resource comprises randomly selecting the SR resource.

In some aspects, the indication is via a SIB or a dedicated RRC signal.

In some aspects, the SR is unsourced.

In some aspects, the SR comprises a request for multiple UL resources.

In some aspects, method 1000 further includes determining the MCS information based on an open loop measurement or an earlier MCS.

In some aspects, the SR resource pool comprises at least one of: at least one sequence set, wherein the at least one sequence set comprises a plurality of subsets of sequences, wherein a subset of the plurality of subsets comprises the SR resources, or a plurality of sub-pools, wherein a sub-pool of the plurality of sub-pools comprises the SR resources.

In some aspects, block 1010 includes selecting the sub-pool, the sub-pool comprising the SR resource, wherein the SR resource is a randomly selected resource of the sub-pool.

In some aspects, block 1010 includes selecting, based on the SR, the subset of the plurality of subsets comprising the SR resource, wherein the SR resource is a randomly selected sequence from the subset.

In some aspects, a first sub-pool of the plurality of sub-pools is associated with a first number of SR repetitions and a second sub-pool of the plurality of sub-pools is associated with a second number of SR repetitions.

In some aspects, at least one of: the first sub-pool is associated with a first selection rule, or the second sub-pool is associated with a second selection rule.

In some aspects, at least one of the first selection rule or the second selection rule is an implicit UE rule based on a UE status.

In some aspects, method 1000 further includes receiving a configuration of at least one of the first selection rule or the second selection rule.

In some aspects, the first selection rule is associated with a first number of symbol sequences and a first number of repetitions, the second selection rule is associated with a second number of symbol sequences and a second number of repetitions.

In some aspects, method 1000 further includes receiving an UL resource grant from a NE in response to the SR.

In some aspects, the UL resource grant is via at least one dedicated DCI field.

In some aspects, the UL resource grant is based on an SR-RNTI.

In some aspects, the SR-RNTI is based on a resource location or a sequence ID in the SR resource pool, wherein the SR-RNTI associates the UE with the SR.

In some aspects, receiving the UL resource grant comprises receiving the UL resource grant via a DCI transmission comprising a CRC that is scrambled using an SR-RNTI associated with the UE.

In some aspects, the SR-RNTI is based on a resource location, and the DCI transmission indicates information regarding a plurality of sequences associated with the resource location.

In some aspects, the DCI transmission includes information associated with PDSCH resources containing grant information of the UL resource grant.

In some aspects, method 1000 further includes monitoring for the SR-RNTI during an SR-RNTI monitoring window after the SR.

In some aspects, method 1000 further includes resending the SR on the SR resource in association with the UE failing to receive the UL resource grant with the SR-RNTI during the SR-RNTI monitoring window.

In some aspects, the UL resource grant is for a UL resource and the method further comprises sending UL data on the UL resource.

In some aspects, the UL data comprises a UE identifier.

In some aspects, the UL data comprises a request for additional UL resources.

In some aspects, method 1000 further includes obtaining a retransmission UL resource grant for the UL data.

In some aspects, method 1000 further includes resending the SR in association with at least one of a retransmission UL resource grant or a failure to receive a UL resource grant within a specific duration.

In some aspects, resending the SR comprises resending the SR with power ramping.

In some aspects, resending the SR comprises resending the SR on another SR resource of the SR resource pool, on another SR resource pool, or in association with a delay.

In some aspects, method 1000 further includes sending a PRACH based on a number of failed SR retransmissions.

In some aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative operations are possible consistent with this disclosure.

### Example Communications Device

FIG. 11 depicts aspects of an example communications device 1100 configured for wireless communications. In some aspects, communications device 1100 is a user equipment, such as UE 104 described above with respect to FIG. 1 or UE 304 described with respect to FIG. 3.

The communications device 1100 includes a processing system 1102 coupled to a transceiver 1138 (e.g., a transmitter and/or a receiver). The transceiver 1138 is configured to transmit and receive signals for the communications device 1100 via an antenna 1140, such as the various signals as described herein. The processing system 1102 may be configured to perform processing functions for the communications device 1100, including processing signals received and/or to be transmitted by the communications device 1100.

The processing system 1102 includes one or more processors 1104 and a computer-readable medium/memory 1120. In various aspects, the one or more processors 1104 may be representative of the one or more processors 318 described with respect to FIG. 3. The one or more processors 1104 are coupled to a computer-readable medium/memory 1120 via a bus 1136. In some aspects, the computer-readable medium/memory 1120 may be representative of the one or more memories 320 described with respect to FIG. 3. The computer-readable medium/memory 1120 is a non-transitory computer-readable medium/memory. In certain aspects, the computer-readable medium/memory 1120 is configured to store instructions (e.g., computer-executable code), that when executed by the one or more processors 1104, cause the one or more processors 1104 to perform the method 1000 described with respect to FIG. 10, or any aspect related to it, including any operations described in relation to FIG. 10. Note that reference to a processor performing a function of communications device 1100 may include one or more processors performing that function of communications device 1100, such as in a distributed fashion.

In the depicted example, computer-readable medium/memory 1120 stores code (e.g., executable instructions), including code for receiving 1122, code for sending 1124, code for determining 1126, code for selecting 1128, code for monitoring 1130, code for resending 1132, and code for obtaining 1134. Processing of the code 1122-1134 may enable and cause the communications device 1100 to perform the method 1000 described with respect to FIG. 10, or any aspect related to it.

The one or more processors 1104 include circuitry configured to implement (e.g., execute) the code stored in the computer-readable medium/memory 1120, including circuitry for receiving 1106, circuitry for sending 1108, circuitry for determining 1110, circuitry for selecting 1112, circuitry for monitoring 1114, circuitry for resending 1116, and circuitry for obtaining 1118. Processing with circuitry 1106-1118 may enable and cause the communications device 1100 to perform the method 1000 described with respect to FIG. 10, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1138 and/or antenna 1140 of the communications device 1100 in FIG. 11, and/or one or more processors 1104 of the communications device 1100 in FIG. 11. Means for communicating, receiving or obtaining may include the one or more transceivers 324, one or more antennas 322, and/or processing system 316 of the UE 304 illustrated in FIG. 3, transceiver 1138 and/or antenna 1140 of the communications device 1100 in FIG. 11, and/or one or more processors 1104 of the communications device 1100 in FIG. 11.

### Example Operations of a Network Entity

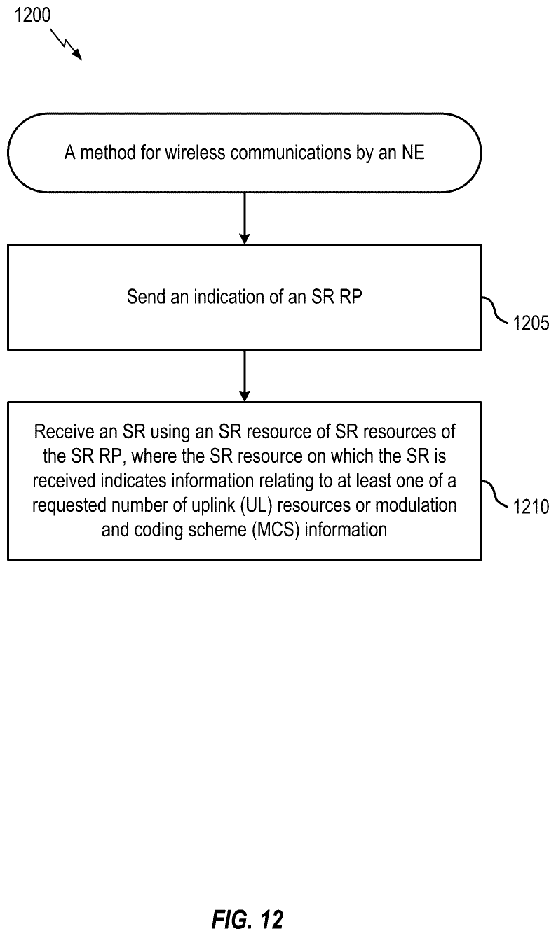

FIG. 12 shows a method 1200 for wireless communications by an NE, such as BS 102 of FIG. 1 or first NE 300 or second NE 302 of FIG. 3.

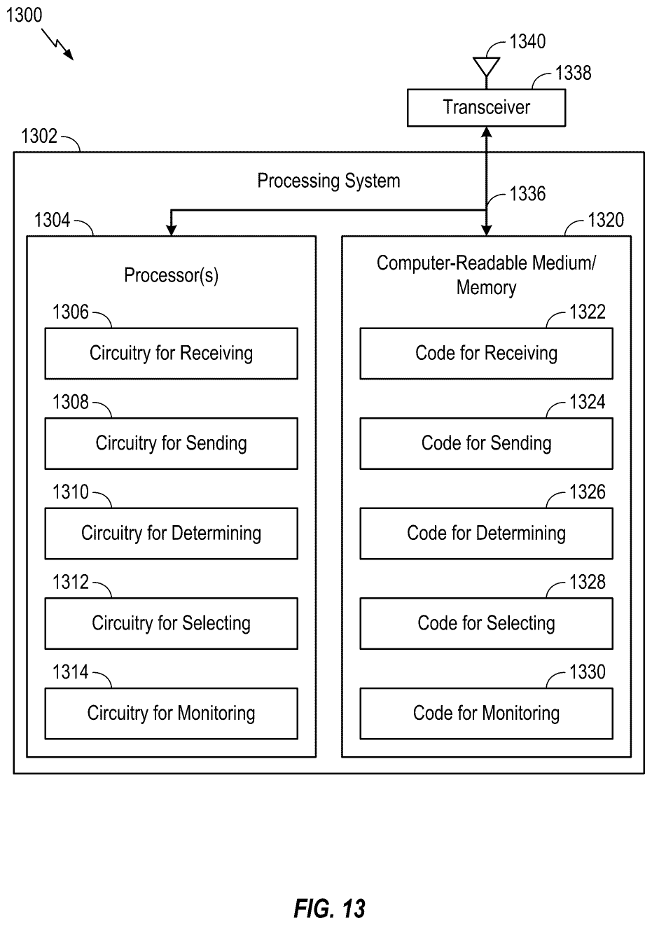

Method 1200 begins at block 1205 with sending an indication of an SR RP. Block 1205 may correspond to 806 of FIG. 8, and 908 or 909 of FIG. 9. Sending an indication of an SR RP (e.g., SR RPs) from an NE provide technical advantages over using PRACH for SRs. Relative to using PRACH for SRs, the resources in an SR RP are allocated to SRs and configured as such, and therefore do not provide information or perform additional processing that is not requested by the UEs, reducing latencies relative to PRACH usage. The block 1205 may also be implemented by a processor, memory, or by an example communications device as described in FIG. 13.

Method 1200 then proceeds to block 1210 with receiving an SR using an SR resource of SR resources of the SR RP, where the SR resource on which the SR is received indicates information relating to at least one of a requested number of UL resources or MCS information. Block 1210 may correspond to 806 of FIG. 8, and 910 or 911 of FIG. 9 The technical benefit of a UE sending the SR on the SR RPs include the flexibility to dynamically configure the number and types of resources allocated for SRs to respond to network conditions such as traffic. Different SR RP configurations that respond to the SRs that are sent on the SR RP may help improve network efficiency based on efficient resource allocation to the SR RPs, by allocating the highest number of resources that can maximize SRs while minimizing effect on other network processes to reduce delays and latencies across the network. The block 1210 may also be implemented by a processor or memory or by an example communications device as described in FIG. 13.

In some aspects, the indication is of a configuration of the SR resources.

In some aspects, the SR resource comprises at least one of a sequence or a time and frequency (time/frequency) resource.

In some aspects, the MCS information comprises an MCS value.

In some aspects, the indication is via a SIB or a dedicated RRC signal.

In some aspects, the SR is unsourced.

In some aspects, the SR comprises a request for multiple UL resources.

In some aspects, the SR resource pool comprises at least one of: at least one sequence set, wherein the at least one sequence set comprises a plurality of subsets of sequences, wherein a subset of the plurality of subsets comprises the SR resources, or a plurality of sub-pools, wherein a sub-pool of the plurality of sub-pools comprises the SR resources.

In some aspects, the sub-pool comprises the SR resource, wherein the SR resource is a randomly selected resource of the sub-pool.

In some aspects, a selected subset of the plurality of subsets comprises the SR resource, wherein the SR resource is a randomly selected sequence from the subset.

In some aspects, a first sub-pool of the plurality of sub-pools is associated with a first number of SR repetitions and a second sub-pool of the plurality of sub-pools is associated with a second number of SR repetitions.

In some aspects, at least one of: the first sub-pool is associated with a first selection rule, or the second sub-pool is associated with a second selection rule.

In some aspects, at least one of the first selection rule or the second selection rule is an implicit UE rule based on a UE status.

In some aspects, method 1200 further includes sending a configuration of at least one of the first selection rule or the second selection rule.

In some aspects, the first selection rule is associated with a first number of symbol sequences and a first number of repetitions, the second selection rule is associated with a second number of symbol sequences and a second number of repetitions.

In some aspects, method 1000 further includes sending a UL resource grant in response to the SR.

In some aspects, the UL resource grant is via at least one dedicated DCI field.

In some aspects, the UL resource grant is based on an SR-RNTI.

In some aspects, the SR-RNTI is based on a resource location or a sequence ID in the SR resource pool, wherein the SR-RNTI associates a UE with the SR.

In some aspects, receiving the UL resource grant comprises receiving the UL resource grant via a DCI transmission comprising a CRC that is scrambled using an SR-RNTI associated with a UE.

In some aspects, the SR-RNTI is based on a resource location, and the DCI transmission indicates information regarding a plurality of sequences associated with the resource location.

In some aspects, the DCI transmission includes information associated with PDSCH resources containing grant information of the UL resource grant.

In some aspects, method 1200 further includes monitoring for the SR-RNTI during an SR-RNTI monitoring window after the SR.

In some aspects, method 1200 further includes receiving the SR on the SR resource in association with a UE failing to receive the UL resource grant with the SR-RNTI during the SR-RNTI monitoring window.

In some aspects, the UL resource grant is for a UL resource and the method further comprises receiving UL data on the UL resource.

In some aspects, the UL data comprises a UE identifier.

In some aspects, the UL data comprises a request for additional UL resources.

In some aspects, method 1200 further includes sending a retransmission UL resource grant for the UL data.

In some aspects, method 1200 further includes receiving the SR in association with at least one of a retransmission UL resource grant or a failure to receive a UL resource grant within a specific duration.

In some aspects, receiving the SR comprises receiving the SR with power ramping.

In some aspects, receiving the SR comprises receiving the SR on another SR resource of the SR resource pool, on another SR resource pool, or in association with a delay.

In some aspects, method 1200 further includes receiving a PRACH based on a number of failed SR retransmissions.

In some aspect, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300 configured for wireless communications. In some aspects, communications device 1300 is a user equipment, such as BS 102 described above with respect to FIG. 1 or first NE 300 or second NE 302 described with respect to FIG. 3.

The communications device 1300 includes a processing system 1302 coupled to a transceiver 1338 (e.g., a transmitter and/or a receiver). The transceiver 1338 is configured to transmit and receive signals for the communications device 1300 via an antenna 1340, such as the various signals as described herein. The processing system 1302 may be configured to perform processing functions for the communications device 1300, including processing signals received and/or to be transmitted by the communications device 1300.

The processing system 1302 includes one or more processors 1304 and a computer-readable medium/memory 1320. In various aspects, the one or more processors 1304 may be representative of the one or more processors 308a/308b described with respect to FIG. 3. The one or more processors 1304 are coupled to a computer-readable medium/memory 1320 via a bus 1336. In some aspects, the computer-readable medium/memory 1320 may be representative of the one or more memories 310a/310b described with respect to FIG. 3. The computer-readable medium/memory 1320 is a non-transitory computer-readable medium/memory. In certain aspects, the computer-readable medium/memory 1320 is configured to store instructions (e.g., computer-executable code), that when executed by the one or more processors 1304, cause the one or more processors 1304 to perform the method 1200 described with respect to FIG. 12, or any aspect related to it, including any operations described in relation to FIG. 12. Note that reference to a processor performing a function of communications device 1300 may include one or more processors performing that function of communications device 1300, such as in a distributed fashion.

In the depicted example, computer-readable medium/memory 1320 stores code (e.g., executable instructions), including code for receiving 1322, code for sending 1324, code for determining 1326, code for selecting 1328, code for monitoring 1330. Processing of the code 1322-1330 may enable and cause the communications device 1300 to perform the method 1200 described with respect to FIG. 12, or any aspect related to it.

The one or more processors 1304 include circuitry configured to implement (e.g., execute) the code stored in the computer-readable medium/memory 1320, including circuitry for receiving 1306, circuitry for sending 1308, circuitry for determining 1310, circuitry for selecting 1312, circuitry for monitoring 1314. Processing with circuitry 1306-1314 may enable and cause the communications device 1300 to perform the method 1200 described with respect to FIG. 12, or any aspect related to it.

More generally, means for communicating, transmitting, sending or outputting for transmission may include the one or more transceivers 312, one or more antenna 314 and/or processing system 308b of the NE 302 illustrated in FIG. 3, transceiver 1338 and/or antenna 1340 of the communications device 1300 in FIG. 13, and/or one or more processors 1304 of the communications device 1300 in FIG. 13. Means for communicating, receiving or obtaining may include the one or more transceivers 312, one or more antennas 314, and/or processing system 308b of the NE 302 illustrated in FIG. 3, transceiver 1338 and/or antenna 1340 of the communications device 1300 in FIG. 13, and/or one or more processors 1304 of the communications device 1300 in FIG. 13.

### Example Clauses

Implementation examples are described in the following numbered clauses:

Clause 1: A method for wireless communications by a UE comprising: receiving an indication of a SR RP; and sending a SR using an SR resource of SR resources of the SR RP, wherein the SR resource on which the SR is sent indicates information relating to at least one of a requested number of UL resources or MCS information.

Clause 2: The method of Clause 1, wherein the indication is of a configuration of the SR resources.

Clause 3: The method of any one of Clauses 1-2, wherein the SR resource comprises at least one of a sequence or a time and frequency (time/frequency) resource.

Clause 4: The method of any one of Clauses 1-3, wherein the MCS information comprises an MCS value.

Clause 5: The method of any one of Clauses 1-4, wherein sending the SR on the SR resource comprises randomly selecting the SR resource.

Clause 6: The method of any one of Clauses 1-5, wherein the indication is via a SIB or a dedicated RRC signal.

Clause 7: The method of any one of Clauses 1-6, wherein the SR is unsourced.

Clause 8: The method of any one of Clauses 1-7, wherein the SR comprises a request for multiple UL resources.

Clause 9: The method of any one of Clauses 1-8, further comprising: determining the MCS information based on an open loop measurement or an earlier MCS.

Clause 10: The method of any one of Clauses 1-9, wherein the SR resource pool comprises at least one of: at least one sequence set, wherein the at least one sequence set comprises a plurality of subsets of sequences, wherein a subset of the plurality of subsets comprises the SR resources, or a plurality of sub-pools, wherein a sub-pool of the plurality of sub-pools comprises the SR resources.

Clause 11: The method of Clause 10, wherein sending the SR on the SR resource comprises selecting the sub-pool, the sub-pool comprising the SR resource, wherein the SR resource is a randomly selected resource of the sub-pool.

Clause 12: The method of Clause 10, wherein sending the SR on the SR resource comprises selecting, based on the SR, the subset of the plurality of subsets comprising the SR resource, wherein the SR resource is a randomly selected sequence from the subset.

Clause 13: The method of Clause 10, wherein a first sub-pool of the plurality of sub-pools is associated with a first number of SR repetitions and a second sub-pool of the plurality of sub-pools is associated with a second number of SR repetitions.

Clause 14: The method of Clause 13, wherein at least one of: the first sub-pool is associated with a first selection rule, or the second sub-pool is associated with a second selection rule.

Clause 15: The method of Clause 14, wherein at least one of the first selection rule or the second selection rule is an implicit UE rule based on a UE status.

Clause 16: The method of Clause 14, further comprising: receiving a configuration of at least one of the first selection rule or the second selection rule.

Clause 17: The method of Clause 14, wherein the first selection rule is associated with a first number of symbol sequences and a first number of repetitions, the second selection rule is associated with a second number of symbol sequences and a second number of repetitions.

Clause 18: The method of any one of Clauses 1-17, further comprising: receiving an UL resource grant from a NE in response to the SR.

Clause 19: The method of Clause 18, wherein the UL resource grant is via at least one dedicated DCI field.

Clause 20: The method of Clause 18, wherein the UL resource grant is based on an SR-RNTI.

Clause 21: The method of Clause 20, wherein the SR-RNTI is based on a resource location or a sequence ID in the SR resource pool, wherein the SR-RNTI associates the UE with the SR.

Clause 22: The method of Clause 18, wherein receiving the UL resource grant comprises receiving the UL resource grant via a DCI transmission comprising a CRC that is scrambled using an SR-RNTI associated with the UE.

Clause 23: The method of Clause 22, wherein the SR-RNTI is based on a resource location, and the DCI transmission indicates information regarding a plurality of sequences associated with the resource location.

Clause 24: The method of Clause 22, wherein the DCI transmission includes information associated with PDSCH resources containing grant information of the UL resource grant.

Clause 25: The method of Clause 24, further comprising: monitoring for the SR-RNTI during an SR-RNTI monitoring window after the SR.

Clause 26: The method of Clause 25, further comprising: resending the SR on the SR resource in association with the UE failing to receive the UL resource grant with the SR-RNTI during the SR-RNTI monitoring window.

Clause 27: The method of Clause 18, wherein the UL resource grant is for a UL resource and the method further comprises sending UL data on the UL resource.

Clause 28: The method of Clause 27, wherein the UL data comprises a UE identifier.

Clause 29: The method of Clause 27, wherein the UL data comprises a request for additional UL resources.

Clause 30: The method of Clause 27, further comprising obtaining a retransmission UL resource grant for the UL data.

Clause 31: The method of Clause 27, further comprising: resending the SR in association with at least one of a retransmission UL resource grant or a failure to receive a UL resource grant within a specific duration.

Clause 32: The method of Clause 31, wherein resending the SR comprises resending the SR with power ramping.

Clause 33: The method of Clause 31, wherein resending the SR comprises resending the SR on another SR resource of the SR resource pool, on another SR resource pool, or in association with a delay.

Clause 34: The method of Clause 31, further comprising: sending a PRACH based on a number of failed SR retransmissions.

Clause 35: A method for wireless communications by an NE comprising: sending an indication of a scheduling request (SR) resource pool (SR RP); and receiving an SR using an SR resource of SR resources of the SR RP, wherein the SR resource on which the SR is received indicates information relating to at least one of a requested number of uplink (UL) resources or modulation and coding scheme (MCS) information.

Clause 36: The method of Clause 35, wherein the indication is of a configuration of the SR resources.

Clause 37: The method of any of Clauses 35-36, wherein the SR resource comprises at least one of a sequence or a time and frequency (time/frequency) resource.

Clause 38: The method of any of Clauses 35-37, wherein the MCS information comprises an MCS value.

Clause 39: The method of any of Clauses 35-38, wherein the SR resource pool comprises at least one of: at least one sequence set, wherein the at least one sequence set comprises a plurality of subsets of sequences, wherein a subset of the plurality of subsets comprises the SR resources, or a plurality of sub-pools, wherein a sub-pool of the plurality of sub-pools comprises the SR resources.

Clause 40: The method of any of Clauses 35-39, wherein a first sub-pool of the plurality of sub-pools is associated with a first number of SR repetitions and a second sub-pool of the plurality of sub-pools is associated with a second number of SR repetitions.

Clause 41: The method of any of Clauses 35-40, wherein at least one of: the first sub-pool is associated with a first selection rule, or the second sub-pool is associated with a second selection rule.

Clause 42: The method of any of Clauses 35-41, further comprising: sending a configuration of at least one of the first selection rule or the second selection rule.

Clause 43: The method of any of Clauses 35-42, wherein the first selection rule is associated with a first number of symbol sequences and a first number of repetitions, the second selection rule is associated with a second number of symbol sequences and a second number of repetitions.

Clause 44: The method of any of Clauses 35-43, further comprising: sending an uplink (UL) resource grant to a user equipment (UE) in response to the SR.

Clause 45: The method of any of Clauses 35-44, wherein the UL resource grant is based on an SR radio network temporary identifier (SR-RNTI), wherein the SR-RNTI is based on a resource location or a sequence identifier (ID) in the SR resource pool, and wherein the SR-RNTI associates the UE with the SR.

Clause 46: The method of any of Clauses 35-45, further comprising: receiving the SR in association with at least one of a retransmission UL resource grant or a UE failure to receive a UL resource grant within a specific duration.

Clause 47: One or more apparatuses, comprising: one or more memories comprising executable instructions; and one or more processors configured to execute the executable instructions and cause the one or more apparatuses to perform a method in accordance with any one of Clauses 1-46.

Clause 48: One or more apparatuses configured for wireless communications, comprising: one or more memories; and one or more processors, coupled to the one or more memories, configured to cause the one or more apparatuses to perform a method in accordance with any one of Clauses 1-46.

Clause 49: One or more apparatuses configured for wireless communications, comprising: one or more memories; and one or more processors, coupled to the one or more memories, configured to perform a method in accordance with any one of Clauses 1-46.

Clause 50: One or more apparatuses, comprising means for performing a method in accordance with any one of Clauses 1-46.

Clause 51: One or more non-transitory computer-readable media comprising executable instructions that, when executed by one or more processors of one or more apparatuses, cause the one or more apparatuses to perform a method in accordance with any one of Clauses 1-46.

Clause 52: One or more computer program products embodied on one or more computer-readable storage media comprising code for performing a method in accordance with any one of Clauses 1-46.

Clause 53: One or more apparatuses configured for wireless communications, comprising: a processing system that includes one or more processors and one or more memories coupled with the one or more processors, the processing system configured to cause the one or more apparatuses to perform a method in accordance with any one of Clauses 1-46.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive an indication of a scheduling request (SR) resource pool (SR RP); and
send an SR using an SR resource of SR resources of the SR RP, wherein the SR resource on which the SR is sent indicates information relating to at least one of a requested number of uplink (UL) resources or modulation and coding scheme (MCS) information.

2. The apparatus of claim 1, wherein the indication is of a configuration of the SR resources.

3. The apparatus of claim 1, wherein the SR resource comprises at least one of a sequence or a time and frequency (time/frequency) resource.

4. The apparatus of claim 1, wherein the MCS information comprises an MCS value.

5. The apparatus of claim 1, wherein to cause the UE to send the SR on the SR resource, the processing system is configured to cause the UE to randomly select the SR resource.

6. The apparatus of claim 1, wherein the SR resource pool comprises at least one of:
at least one sequence set, wherein the at least one sequence set comprises a plurality of subsets of sequences, wherein a subset of the plurality of subsets comprises the SR resources, or
a plurality of sub-pools, wherein a sub-pool of the plurality of sub-pools comprises the SR resources.

7. The apparatus of claim 6, wherein to cause the UE to send the SR on the SR resource, the processing system is further configured to cause the UE to:
select the sub-pool, the sub-pool comprising the SR resource, wherein the SR resource is a randomly selected resource of the sub-pool.

8. The apparatus of claim 6, wherein to cause the apparatus to send the SR on the SR resource, the processing system is further configured to cause the UE to:
select, based on the SR, the subset of the plurality of subsets comprising the SR resource, wherein the SR resource is a randomly selected sequence from the subset.

9. The apparatus of claim 6, wherein a first sub-pool of the plurality of sub-pools is associated with a first number of SR repetitions and a second sub-pool of the plurality of sub-pools is associated with a second number of SR repetitions.

10. The apparatus of claim 9, wherein at least one of:
the first sub-pool is associated with a first selection rule, or
the second sub-pool is associated with a second selection rule.

11. The apparatus of claim 10, wherein at least one of the first selection rule or the second selection rule is an implicit UE rule based on a UE status.

12. The apparatus of claim 10, wherein the processing system is further configured to cause the UE to:
receive a configuration of at least one of the first selection rule or the second selection rule.

13. The apparatus of claim 10, wherein the first selection rule is associated with a first number of symbol sequences and a first number of repetitions, the second selection rule is associated with a second number of symbol sequences and a second number of repetitions.

14. The apparatus of claim 1, wherein the processing system is further configured to cause the UE to:
receive an uplink (UL) resource grant from a network entity (NE) in response to the SR.

15. The apparatus of claim 14, wherein the UL resource grant is based on an SR radio network temporary identifier (SR-RNTI), wherein the SR-RNTI is based on a resource location or a sequence identifier (ID) in the SR resource pool, and wherein the SR-RNTI associates the UE with the SR.

16. The apparatus of claim 15, wherein the processing system is further configured to cause the UE to:
monitor for the SR-RNTI during an SR-RNTI monitoring window after the SR.

17. The apparatus of claim 16, wherein the processing system is further configured to cause the UE to:
resend the SR on the SR resource in association with the UE failing to receive the UL resource grant with the SR-RNTI during the SR-RNTI monitoring window.

18. The apparatus of claim 1, wherein the processing system is further configured to cause the UE to:
resend the SR in association with at least one of a retransmission UL resource grant or a failure to receive a UL resource grant within a specific duration.

19. A method for wireless communications, comprising:
receiving an indication of a scheduling request (SR) resource pool (SR RP); and
sending an SR using an SR resource of SR resources of the SR RP, wherein the SR resource on which the SR is sent indicates information relating to at least one of a requested number of uplink (UL) resources or modulation and coding scheme (MCS) information.

20. An apparatus for wireless communications, comprising:
means for receiving an indication of a scheduling request (SR) resource pool (SR RP); and
means for sending an SR using an SR resource of SR resources of the SR RP, wherein the SR resource on which the SR is sent indicates information relating to at least one of a requested number of uplink (UL) resources or modulation and coding scheme (MCS) information.

21. An apparatus for wireless communications, comprising a processing system that includes one or more processors and one or more memories coupled with the one or more processors, the processing system configured to cause a network entity (NE) to:
send an indication of a scheduling request (SR) resource pool (SR RP); and
receive an SR on an SR resource of SR resources of the SR RP, wherein the SR resource on which the SR is received indicates information relating to at least one of a requested number of uplink (UL) resources or modulation and coding scheme (MCS) information.

22. The apparatus of claim 21, wherein the SR resource comprises at least one of a sequence or a time and frequency (time/frequency) resource.

23. The apparatus of claim 21, wherein the SR resource pool comprises at least one of:
at least one sequence set, wherein the at least one sequence set comprises a plurality of subsets of sequences, wherein a subset of the plurality of subsets comprises the SR resources, or
a plurality of sub-pools, wherein a sub-pool of the plurality of sub-pools comprises the SR resources.

24. The apparatus of claim 23, wherein a first sub-pool of the plurality of sub-pools is associated with a first number of SR repetitions and a second sub-pool of the plurality of sub-pools is associated with a second number of SR repetitions.

25. The apparatus of claim 24, wherein at least one of:
the first sub-pool is associated with a first selection rule, or
the second sub-pool is associated with a second selection rule.

26. The apparatus of claim 25, wherein the processing system is further configured to cause the NE to:
send a configuration of at least one of the first selection rule or the second selection rule.

27. The apparatus of claim 25, wherein the first selection rule is associated with a first number of symbol sequences and a first number of repetitions, the second selection rule is associated with a second number of symbol sequences and a second number of repetitions.

28. The apparatus of claim 21, wherein the processing system is further configured to cause the NE to:
send an uplink (UL) resource grant to a user equipment (UE) in response to the SR.

29. The apparatus of claim 28, wherein the UL resource grant is based on an SR radio network temporary identifier (SR-RNTI), wherein the SR-RNTI is based on a resource location or a sequence identifier (ID) in the SR resource pool, and wherein the SR-RNTI associates the UE with the SR.

30. The apparatus of claim 21, wherein the processing system is further configured to cause the NE to:
receive the SR in association with at least one of a retransmission UL resource grant or a UE failure to receive a UL resource grant within a specific duration.
